(19) United States
(12) Patent Application Publication
(10) Pub. No.: US 2006/0088803 A1
(43) Pub. Date: Apr. 27, 2006

(54) Apparatus and method for tactile writing therapy

(76) Inventors: Ronni S. Bianco, Aventura, FL (US); Carolyn Murray-Slutsky, Hollywood, FL (US)

Correspondence Address: PAUL D. BIANCO: FLEIT, KAIN, GIBBONS,;GUTMAN, BONGINI, & BIANCO P.L., 21355 EAST DIXIE HIGHWAY, SUITE 115, MIAMI, FL, 33180, US

(21) Appl. No.: 10/972,808

(22) Filed: Oct. 25, 2004

(51) Int. Cl. G09B 11/04

(52) U.S. Cl. 434/163

(57) ABSTRACT

An occupational therapy device for improving writing skills. The device includes a tactile member having at least one textured surface. A transparent sheet is positionable over the textured surface of the tactile member, and at least one character is viewable through the transparent sheet.

### FIELD OF THE INVENTION

The present invention relates to an apparatus and method for diagnosing and teaching daily life activities. In particular, the invention relates to an educational or occupational therapy device and method for enhancing a student's learning skills, and more specifically, for improving writing skills through tactile feedback.

### BACKGROUND OF THE INVENTION

Occupational therapy is the therapeutic use of self-care, work, and recreational activities to increase independent function, enhance development, and prevent disability. The goals of occupational therapy include directing participation in selected tasks to restore, reinforce, and enhance physical performance; facilitating the learning of skills and functions essential for adaptation and productivity; and promoting and maintain health. Many devices have been developed for students to aid in their rehabilitation.

For example, U.S. Pat. No. 3,238,643 discloses a kinesthetic teaching device including a flat surface sheet capable of being written on, a flat solid backing sheet of magnetizable metal material immediately under the surface sheet, a support board on which the surface sheet and backing sheet are secured, and a stylus magnetized at one end for attraction to the backing sheet to perceptibly impede the passage of the end of the stylus over the surface sheet when it is used to trace writing on the surface sheet.

U.S. Pat. No. 3,950,863 discloses a method and device for teaching children alphabet recognition and learning handwriting in which a plurality of transparencies are provided, each with one of the nine basic shapes required to construct all the letters, lower and upper case, and a transparency of a figure, such as a house, is also provided with the floors or stories defining the desired spacing. The transparencies are superimposed stepwise to construct a given letter in the spatial boundaries and the child, using a kit comprised of a card on which the figure is represented and components, such as plastic pieces, in the form of the nine basic shapes, repeats the demonstrated method. Thereafter, the child repeats the letter constructing process by removably placing basic letter components on a picture of the figure on the wall or easel so that the teacher may observe the child's learning progress. Finally, the child draws the letters on papers having horizontal lines spaced apart for proper placement of the letters.

U.S. Pat. No. 4,089,126 discloses an apparatus designed to instill the right habits of writing in the mind and reflexes of a little child. Due to the resistance offered by the tension plate to the tip of the pencil, the apparatus induces an exaggerated and determined effort of the child's hand, producing a more prominent and willed imitation of the letter-pattern, thus affording a decisive reversal of the optically revered image of the letter that the eye naturally presents to the brain.

U.S. Pat. No. 4,425,095 discloses a writing aid including a contoured surface having a plurality of relatively depressed surface portions and raised ridges or surface regions at least partially surrounding each depressed surface portion at a level differing therefrom by an amount rendering transition between a ridge or region and a depressed portion tangible to a person through a hand-held writing implement traversing the surface. The contoured surface may be provided by embossing writing paper or embedding threads therein, or may be provided on a substrate or backing sheet for a piece of plain paper.

There exists a need for an occupational therapy device and method that improves a student's ability to recognize and write a letter, number, or other character. It is an object of the present invention to provide tactile feedback or resistant force to impede the tracing of the letter or number so that the kinesthetic sense of the student is intensified. It is also an object of the invention to provide an occupational therapy device which is easy to set-up and may be easily transported for use at home, school, a rehabilitation facility, or in a vehicle. Furthermore, the invention allows for repeated use reducing the need for copying and eliminating the disposal of used sheets of paper.

Other objects and advantages will become apparent from the following description in conjunction with the accompanying drawings.

### SUMMARY OF THE INVENTION

The present invention provides apparatus and methods for occupational therapy. In accordance with one aspect of the invention, an occupational therapy device includes a tactile member having at least one textured surface, a transparent sheet positionable over the textured surface of the tactile member, and at least one character viewable through the transparent sheet. The character may be disposed on a character page which may be positioned between the tactile member and the transparent sheet.

In accordance with another aspect of the present invention, an occupational therapy device includes a sleeve having top and bottom sheets attached to each other along at least one edge. The top sheet is made of transparent material. A tactile member having at least one textured surface is positionable between the top and bottom sheets of the sleeve. At least one character is viewable through the top sheet. The character may be disposed on a character page which may be positioned between the tactile member and the top sheet.

In accordance with a further aspect of the present invention, an occupational therapy device includes an integrated sleeve having a writing sheet and texture sheet. The writing sheet is made of a transparent material, and the texture sheet has a textured surface. The writing and texture sheets are attached to each other along at least one edge with the textured surface positioned toward the writing sheet. A character page has at least one character disposed thereon and is configured for placement between the writing and texture sheets with the characters positioned toward the writing sheet.

The character page may include a character disposed on the front and back surfaces of the page. Additionally, the textured surface of the textile member may include a character disposed thereon. The tactile member may also include two textured surfaces, each surface having a character disposed thereon. Furthermore, the transparent sheet, the top sheet of the sleeve, or the writing sheet of the integrated sleeve may include a character disposed thereon. The character may be disposed on the back surface of the transparent, top, or writing sheet. The character may be formed with broken lines, faded lines, or dots.

In accordance with another aspect of the present invention, a method of improving a student's writing skills is provided. The method includes positioning a transparent sheet over a textured sheet of a tactile member, positioning a character page between the transparent sheet and the tactile member with a character of the character page viewable through the transparent sheet, and tracing the character from the character page onto the transparent sheet using a writing instrument.

In accordance with a further aspect of the present invention, a method of improving a student's writing skills is provided. The method includes positioning a tactile member between top and bottom sheets of a sleeve with a textured surface of the tactile member facing toward the top sheet, positioning a character page between the tactile member and the top sheet with a character of the character page viewable through the top sheet, and tracing the character from the character page onto the top sheet using a writing instrument.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an exemplary embodiment of the present invention including a writing sleeve, a character page, and a tactile member;

FIG. 2 is an exemplary embodiment including a writing sleeve and a tactile member having imprinted characters;

FIG. 3 is an exemplary embodiment including a tactile member and a writing sleeve having imprinted characters;

FIG. 4 is an exemplary embodiment including a writing sheet, a character page, and a tactile member;

FIG. 5 is an exemplary embodiment including a writing sheet and a tactile member having imprinted characters;

FIG. 6 is an exemplary embodiment including a writing sheet and a tactile member attached along one edge;

FIG. 7 is an exemplary embodiment including a tactile member and a writing sheet having imprinted characters; and

FIG. 8 is an exemplary embodiment including a character page and an integrated sleeve having a textured surface and a writing surface.

### DETAILED DESCRIPTION OF THE INVENTION

The present invention provides occupational therapy devices and methods for improving the writing skills of a student. The invention permits the student to trace a character with a writing instrument while receiving tactile feedback from a non-smooth, textured surface under the character.

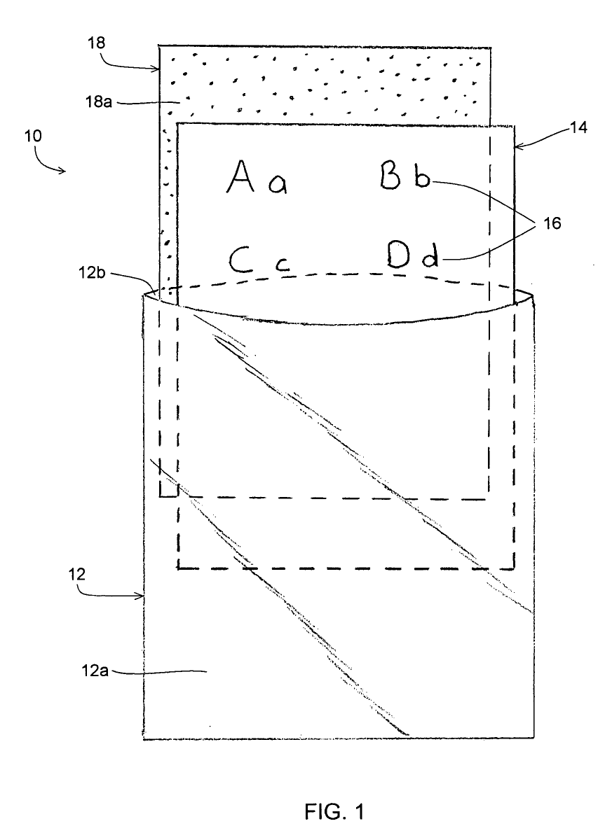

Referring now to the drawing figures in which like reference designators refer to like elements, there is shown in FIG. 1 an exemplary embodiment of the present invention. The tactile therapy device 10 may include a writing sleeve 12, a character page 14, and a tactile member 18. The writing sleeve 12 may include two sheets with a top sheet 12a positioned generally on top of and laying flat against a bottom sheet 12b. The top and bottom sheets 12a and 12b may be attached to one another along at least one edge of the sheets. The sheets 12a and 12b may be attached with glue, heat bondable material, a spiral binding, a clip, or any other means known to bond two sheets of material together. Preferably, the top and bottom sheets 12a and 12b are attached along three edges to form a pouch-like sleeve with one access port. The top and bottom sheets 12a and 12b may be made of plastic, acrylic, glass, clothe, paper, cardboard, and/or wood. In a preferred embodiment, the top sheet 12a is made of a transparent plastic material. The transparent plastic material may include means for marking and erasing. For example, an erasable ink marker, pen, or pencil (such as a grease pencil or a lead based pencil) may be used to mark on the top sheet, and a sponge, cloth, rag, tissue, or paper towel may be used to remove the marks from the top sheet 12a.

The character page 14 includes a character or plurality of characters 16 printed or disposed on a surface of the page 14. The characters 16 may be letters, numbers, words, symbols, pictures, or any other designs. The characters 16 may be disposed on any of the surfaces of the character page 14. In one embodiment, the characters 16 are disposed on the front surface of the page 14. In another embodiment, the characters 16 are disposed on the front and back surfaces of the page 14. The character page 14 may be dimensioned and configured to fit between the top and bottom sheets 12a and 12b of the writing sleeve 12. Preferably, the character page 14 is dimension to fit through the access port of the pouch-like writing sleeve 12 and to lay flat between the top and bottom sheets 12a and 12b. The character page 14 may be made of plastic, acrylic, cloth, paper, or any other thin, flexible material. In a preferred embodiment, the character page 14 is made of paper with the characters 16 printed on the front and/or back of the page 14.

The tactile member 18 includes at least one textured surface 18a. The textured surface 18a may include bumps, ridges, indentations, peaks and valleys, grit, sand, or other means for creating texture. The textured surface 18a of the tactile member 18 is designed and configured to provide tactile feedback to a person moving a writing instrument or like instrument across the tactile member 18. Preferably, the amount of tactile feedback is sufficient to be felt by the student when writing. At the same time, the amount of tactile feedback should not be excessive such that the writing instrument can not be moved across the tactile member 18.

The tactile member 18 may be dimensioned and configured to fit between the top and bottom sheets 12a and 12b of the writing sleeve 12. Preferably, the tactile member 18 is dimension to fit through the access port of the pouch-like writing sleeve 12 and to lay flat between the top and bottom sheets 12a and 12b. The tactile member 18 may be made of plastic, acrylic, cloth, paper, cardboard, wood, ceramic, and/or metal. In a preferred embodiment, the tactile member 18 is a sheet of sandpaper. The textured surface 18a is the gritty surface of the sandpaper. The grit of the sandpaper may be 60 or greater. Preferably, the grit is 100 or greater, like 200 grit sandpaper. It should be understood that the grit of the preferred sandpaper coincides with the standard numerical designations of commercially available sandpaper. That is, the greater the grit number, the less resistance or friction the paper will have.

In use, the tactile therapy device 10 of FIG. 1 provides occupational therapy for persons needing improved writing skills and/or mental concentration. An occupational therapist, teacher, parent, and/or guardian may facilitate the therapy. Alternately, the student may use the tactile therapy device 10 on his or her own. The tactile member 18 is placed between the top and bottom sheets 12a and 12b of the writing sleeve 12 with the textured surface 18a facing the top sheet 12a of the writing sleeve 12. The character page 14 is placed between the tactile member 18 and the top sheet 12a of the writing sleeve 12 with the characters 16 on the page 14 facing the top sheet 12a of the writing sleeve 12.

The student may use an erasable marker or like instrument to trace the characters 16 of the character page 14 onto the top sheet 12a of the writing sleeve 12. As the student moves the marker across the top sheet 12a to trace the characters 16, the student feels the textured surface 18a of the tactile member 18 through the marker. The combination of sight and feel improves the student's writing skills while maintaining the student's concentration. After the characters 16 have been traced, the markings may be erased from the top sheet 12a of the writing sleeve 12. For additional therapy, the character page 14 may be flipped over, and the character or plurality of characters 16 on the other side of the page 14 may be traced. Alternatively, the character page 14 may be removed, and another page with different characters may be inserted.

The tactile member 18 may also be substituted for another tactile member having a different texture or different resistance. For example, if the student is having difficulty tracing the characters 16 because the textured surface 18a of the tactile member 18 is too coarse, the tactile member 18 may be replaced with one having less resistance. Conversely, if the student is not receiving sufficient tactile feedback through the writing instrument, the tactile member 18 may be replaced with one having a coarser textured surface.

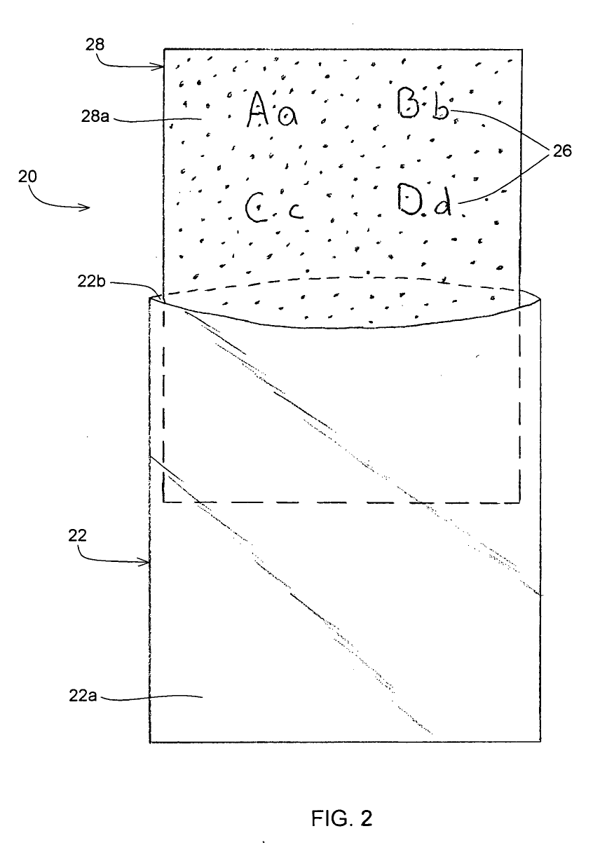

FIG. 2 illustrates another exemplary embodiment of the present invention. The tactile therapy device 20 includes a writing sleeve 22 and a tactile member 28 with a character or plurality of characters 26 printed thereon. The writing sleeve 22 may include the features as described above in the embodiment of FIG. 1. The tactile member 28 may also include the features as described above. Additionally, the tactile member 28 of FIG. 2 includes characters 26 disposed on the textured surface 28a of the tactile member 28. The characters 26 may be similar to and may include the features of the characters of the character page of FIG. 1.

The tactile therapy device 20 of FIG. 2 is used similar to the device 10 of FIG. 1 except that no character page is placed between the top and bottom sheets 22a and 22b of the writing sleeve 22. Instead, when the tactile member 28 is placed between the sheets 22a and 22b of the writing sleeve 22, the textured surface 28a containing the characters 26 is positioned against the top sheet 22a. The characters 26 can be seen through the transparent plastic top sheet 22a and can therefore be traced with a writing instrument such as an erasable marker, pen, or pencil.

Furthermore, the tactile member 28 may include characters 26 on two surfaces. For example, the front side of the tactile member 28 may include a textured surface with characters, while the back side of the tactile member 28 may include a textured surface with more characters. The front and back sides of the tactile member 28 may also include the same or different textured surfaces. One side may be coarser than the other thereby providing increased tactile feedback to the student. In use, the tactile member 28 having two textured surfaces with characters thereon may be flipped or reversed from between the top and back sheets 22a and 22b of the writing sleeve 22 to provide different resistances to the writing instrument and student.

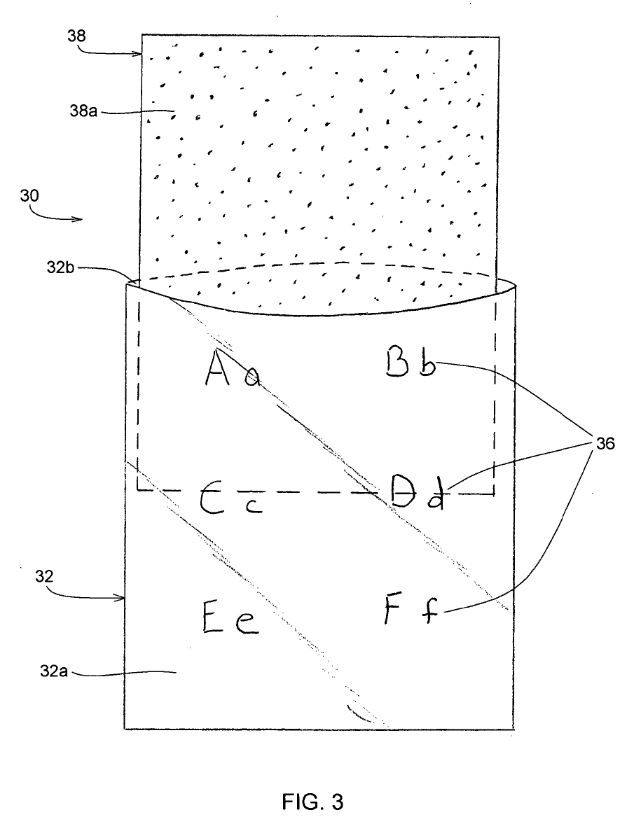

In an exemplary embodiment illustrated in FIG. 3, the tactile therapy device 30 includes a tactile member 38 and a writing sleeve 32 with a character or plurality of characters 36 printed on the top sheet 32a of the writing sleeve 32. The tactile member 38 may include the features of the tactile member of FIG. 1. That is, the tactile member 38 may include at least one textured surface 38a. The top sheet 32a of the writing sleeve 32 includes the characters 36. The characters 36 may be disposed or printed on the front or back side of the top sheet 32a. Preferably, the characters 36 are imprinted on the back side of the top sheet 32a so that when any marks are removed from the front side of the top sheet 32a, the characters 36 are not rubbed or worn off over time.

Additionally, the characters 36 on the top sheet 32a may be printed with light ink or like material so that when the characters 36 are traced with a writing instrument, the characters 36 do not “drown out” the tracing. Alternatively, or additionally, the characters 36 may be formed from broken or faded lines, dashes, dots, or similar markings so that the tracing can be seen over the printed characters 36.

In using the tactile therapy device 30 of FIG. 3, the tactile member 38 is placed between the top and bottom sheets 32a and 32b of the writing sleeve 32. The student may use an erasable marker, pen, or pencil to trace the characters 36 on the front side of the top sheet 32a of the writing sleeve 32. As the student traces the characters 36, the textured surface 38a of the tactile member 38 provides tactile feedback to the student through the writing instrument. The tactile member 38 may be flipped over between the top and bottom sheets 32a and 32b of the writing sleeve 32 to expose another textured surface of the tactile member 38 to the top sheet 32a. The tactile member 38 with two different textured surfaces may provide different tactile feedback to the student.

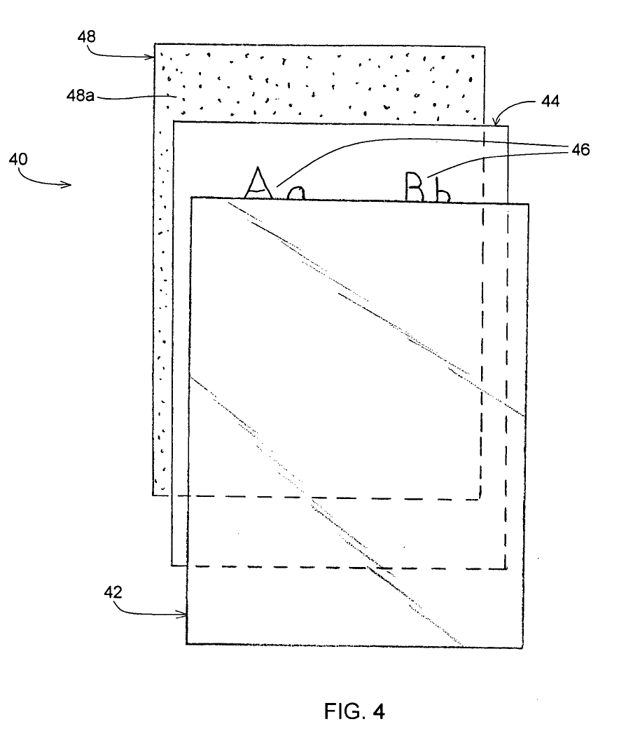

FIG. 4 illustrates another exemplary embodiment of the present invention. The tactile therapy device 40 includes a writing sheet 42, a character page 44, and a tactile member 48. The writing sheet 42 may be a single sheet of material such as plastic, acrylic, glass, cloth, and/or paper. In a preferred embodiment, the writing sheet 42 is made of a transparent plastic material. The transparent plastic material may include means for marking and erasing. For example, an erasable ink marker may be used to mark on the top sheet, and a sponge, cloth, rag, tissue, or paper towel may be used to remove the marks from the writing sheet 42.

The character page 44 may be similar to and include the features of the character page of the tactile therapy device of FIG. 1. That is, the character page 44 includes a character or plurality of characters 46 printed or disposed on a surface of the page 44. The characters 46 may be disposed on any of the surfaces of the character page 44. In a preferred embodiment, the characters 46 are disposed on the front side or surface of the page 44. The character page 44 is dimensioned and configured to lay flat against the writing sheet 42.

The tactile member 48 may include the features of the tactile member described in FIG. 1. The tactile member 48 includes at least one textured surface 48a. The front and/or back sides of the tactile member 48 may include a textured surface 48a. For example, the back side may include a textured surface which is coarser than the textured surface of the front side.

In using the embodiment of FIG. 4, the character page 44 is placed flat on the tactile member 48, and the writing sheet 42 is placed flat on the character page 44. A writing instrument, preferably an erasable marker, pen, or pencil, is used to trace the characters 46 from the character page 44 onto the front side of the writing sheet 42. The tracings may be removed from or wiped off the writing sheet 42. If desired, the character page 44 may be flipped or reversed so that the characters on the back side of the character page 44 may be traced onto the writing sheet 42. Also, the tactile member 48 may be flipped or reversed to increase or decrease the tactile feedback felt by the student.

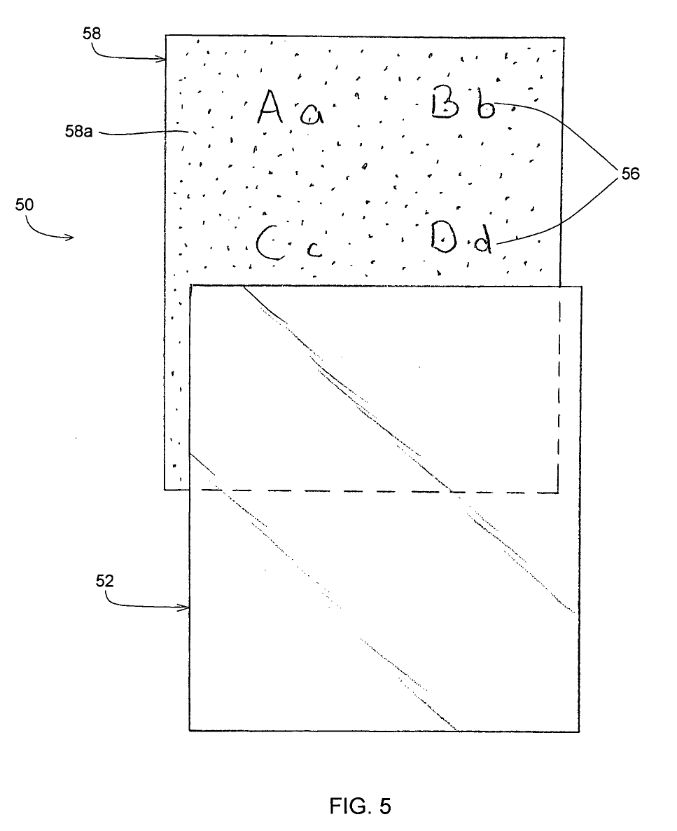

In another embodiment shown in FIG. 5, the tactile writing device 50 includes a writing sheet 52 and a tactile member 58 having a character or plurality of characters 56 printed on at least one textured surface 58a of the tactile member 58. The writing sheet 52 is similar to and includes the features of the writing sheet of FIG. 4. Preferably, the writing sheet 52 is made of transparent, plastic material. The tactile member 58 may include the features of the tactile member of FIG. 2. That is, the tactile member 58 includes characters 56 disposed on at least one textured surface 58a of the tactile member 58. The characters 56 of the tactile member 58 may include the features of the characters described in FIG. 1.

In use, the writing sheet 52 is placed flat against the tactile member 58. The student may trace the characters 56 from the tactile member 58 onto the front side of the writing sheet 52. Preferably, the student traces the characters 56 with an erasable marker, pen, or pencil. The markings on the writing sheet 52 may be erased or removed, and the tactile member 58 flipped or reversed so the student may trace the characters imprinted on the opposite side of the tactile member.

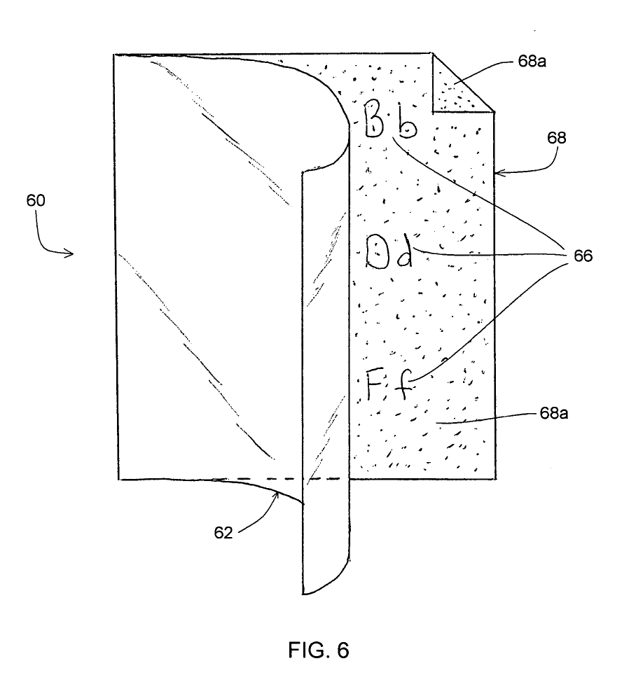

Referring to FIG. 6, the tactile writing device 60 includes a writing sheet 62 and tactile member 68 which may be attached along at least one edge. The writing sheet 62 is similar to and includes the features of the writing sheet of FIG. 4. The tactile member 68 may include a textured surface and characters 66 on both the front and back sides. The characters 66 may include the features of the characters described in FIG. 1. In this configuration, the writing sheet 62 may be positioned on one side of the tactile member 68, and the characters may be traced. Then, the writing sheet 62 may be rotated along the attached edge so the characters 66 on the opposite side of the tactile member 68 may be traced onto the writing sheet 62.

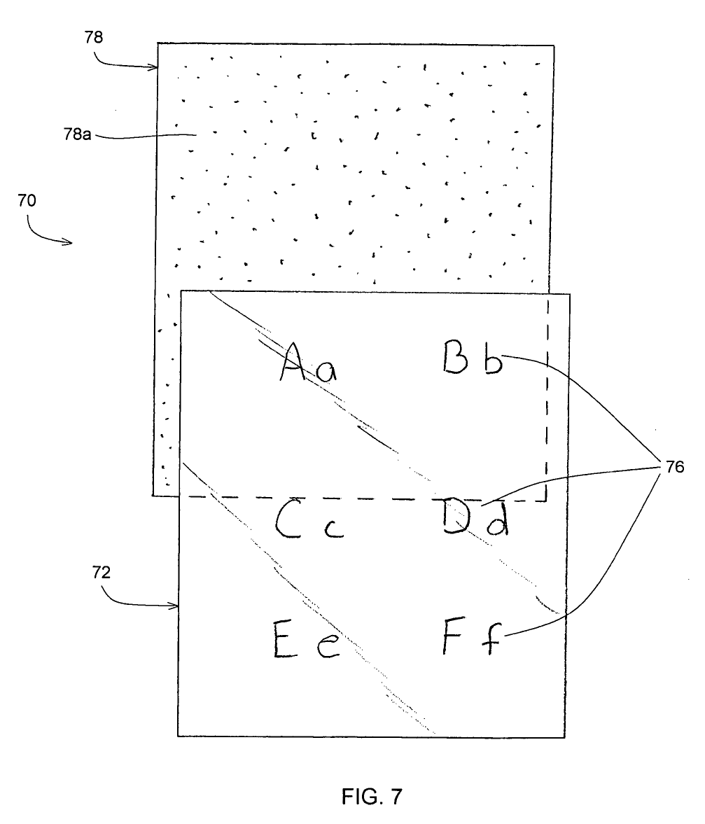

FIG. 7 illustrates another embodiment of the present invention. A tactile therapy device 70 includes a tactile member 78 and a writing sheet 72 with a character or plurality of characters 76 printed on at least one side of the writing sheet 72. The tactile member 78 may include the features of the tactile member of FIG. 1. That is, the tactile member 78 may include at least one textured surface 78a. The writing sheet 72 may include characters 76 disposed or printed on the front and/or back side of the writing sheet 72. Preferably, the characters 76 are imprinted on the back side of the writing sheet 72 so that when erasable marker is removed from the writing sheet 72, the characters 76 are not rubbed or worn off over time.

In use, the writing sheet 72 is placed flat against the tactile member 78. The student may trace the characters 76 onto the front side of the writing sheet 72. The tactile member 78 may be flipped or reversed to provide different tactile feedback to the student.

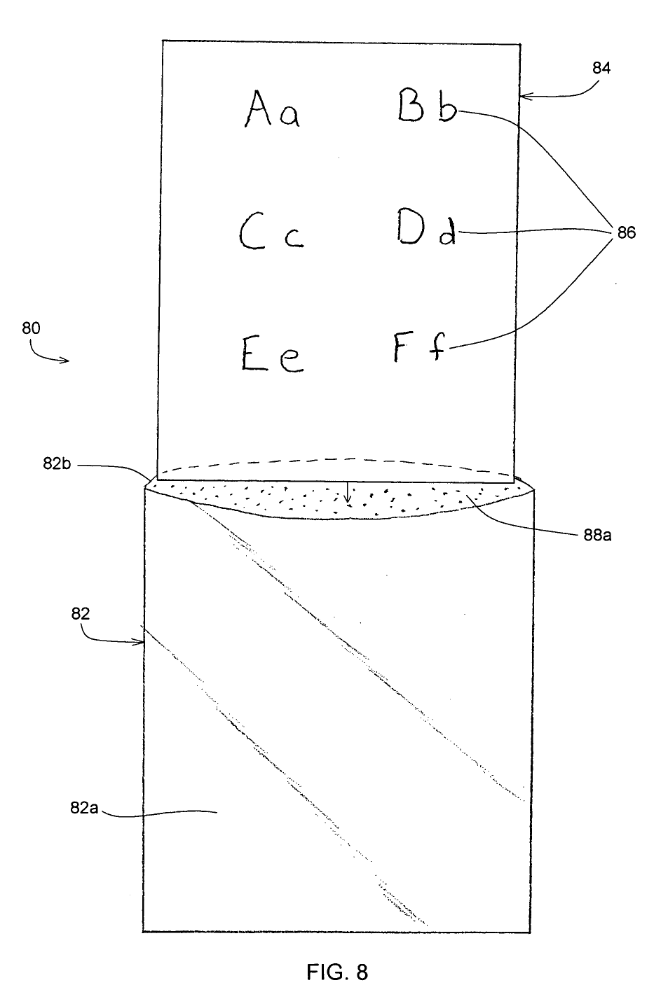

Representing another exemplary embodiment of the present invention, FIG. 8 illustrates a tactile therapy device 80 including a character page 84 and an integrated sleeve 82 having a top writing sheet 82a and a bottom textured sheet 82b. The character page 84 may include a character of plurality of characters 86 disposed thereon. The character page 84 may also include the features of the character page of FIG. 1. The writing sheet 82a of the integrated sleeve 82 may be made from plastic, acrylic, paper, or other like material. The integrated sleeve 82 also includes a textured sheet 82b having at least one textured surface 88a. The writing sheet 82a may be placed flat against the textured surface 88a of the textured sheet 82b, and at least one edge of the sheets 82a and 82b may be held together. Preferably, three edges are bonded together leaving one edge open to form a pouch with an opening. The edges may be bonded with glue, heat bondable material, a spiral binding, a clip, or any other means known to bond two sheets of material together.

In use, the character page 84 may be placed between the writing sheet 82a and textured sheet 82b of the integrated sleeve 82. Preferably, the character page 84 is slid through an opening formed when the writing sheet 82a and textured sheet 82b are attached along three edges. With the character page 84 in place, the student may trace the characters 86 from the character page 84 onto the writing sheet 82a of the integrated sleeve 82. The student may use an erasable marker, pen, or pencil.

It is contemplated that the character or plurality of characters of the present invention may be printed with black, white, or colored ink. Also, the sheets, sleeves, pages, and/or tactile members of the present invention may be white, black, or colored.

It is also contemplated that the above described embodiments may not include a character or plurality characters which the student may trace. Instead, the student may write or draw freehand, without tracing. For example, there may be horizontal lines printed on the tactile therapy device that the student may use as a guideline to write freehand. In addition, there may be a square, rectangle, circle, or like object imprinted on the tactile therapy device that the student may draw within using freehand. Even without characters to trace, the tactile therapy device may provide the student with tactile feedback from the textured surface while writing or drawing.

It is further contemplated that the above described embodiments may be anchored to a hard surface like a board, table, wall, or similar object. Anchoring the device to a table, for example, will keep the device together and prevent undesired movement of a sheet, page, sleeve, etc. when the student is writing or tracing.

All references cited herein are expressly incorporated by reference in their entirety.

It will be appreciated by persons skilled in the art that the present invention is not limited to what has been particularly shown and described herein above. For example, the specification discloses a number of different embodiments and the present invention envisions combining certain features from one embodiment with certain features from another embodiment. In addition, unless mention was made above to the contrary, it should be noted that all of the accompanying drawings are not to scale. A variety of modifications and variations are possible in light of the above teachings without departing from the scope and spirit of the invention.

What is claimed is:

1. An occupational therapy device for improving writing skills, the device comprising:
a tactile member having at least one textured surface;
a transparent sheet positionable over the textured surface of the tactile member; and
at least one character viewable through the transparent sheet.

2. The occupational therapy device of claim 1 wherein the at least one character is disposed on a character page, the character page positionable between the tactile member and the transparent sheet.

3. The occupational therapy device of claim 2 wherein the character page includes at least one character disposed on front and back surfaces of the character page.

4. The occupational therapy device of claim 1 wherein the at least one character is disposed on the at least one textured surface of the tactile member.

5. The occupational therapy device of claim 4 wherein the tactile member includes two textured surfaces, each textured surface having at least one character disposed thereon.

6. The occupational therapy device of claim 1 wherein the at least one character is disposed on the transparent sheet.

7. The occupational therapy device of claim 6 wherein the at least one character is disposed on a back surface of the transparent sheet, the back surface positioned against the tactile member.

8. The occupational therapy device of claim 7 wherein the at least one character is formed with one of broken lines, faded lines, and dots.

9. An occupational therapy device for improving writing skills, the device comprising:
a sleeve having top and bottom sheets, the sheets attached to each other along at least one edge, the top sheet made of transparent material;
a tactile member having at least one textured surface, the tactile member positionable between the top and bottom sheets of the sleeve with the textured surface positioned toward the top sheet; and
at least one character viewable while looking at the top sheet.

10. The occupational therapy device of claim 9 wherein the at least one character is disposed on a character page, the character page positionable between the top and bottom sheets of the sleeve with the at least one character positioned toward the top sheet.

11. The occupational therapy device of claim 10 wherein the character page includes at least one character disposed on front and back sides of the character page.

12. The occupational therapy device of claim 9 wherein the at least one character is disposed on the at least one textured surface of the tactile member.

13. The occupational therapy device of claim 12 wherein the tactile member includes two textured surfaces, each textured surface having at least one character disposed thereon.

14. The occupational therapy device of claim 9 wherein the at least one character is disposed on the top sheet.

15. The occupational therapy device of claim 14 wherein the at least one character is disposed on a back surface of the top sheet, the back surface positioned against the tactile member.

16. The occupational therapy device of claim 15 wherein the at least one character is formed with one of broken lines, faded lines, and dots.

17. An occupational therapy device for improving writing skills, the device comprising:
an integrated sleeve including a writing sheet and texture sheet, the writing sheet made of a transparent material and the texture sheet having a textured surface, the sheets attached to each other along at least one edge with the textured surface of the texture sheet positioned toward the writing sheet; and
a character page having at least one character disposed thereon, the character page configured for placement between the writing and texture sheets with the at least one character positioned toward the writing sheet.

18. A method of improving writing skills using the device of claim 2, the method comprising:
positioning the transparent sheet over the textured surface of the tactile member;
positioning the character page between the transparent sheet and the tactile member with the at least one character viewable through the transparent sheet; and
tracing the at least one character from the character page onto the transparent sheet using a writing instrument.

19. A method of improving writing skills using the device of claim 10, the method comprising:
positioning the tactile member between the top and bottom sheets of the sleeve with the at least one textured surface facing toward the top sheet;
positioning the character page between the tactile member and the top sheet of the sleeve with the at least one character viewable through the top sheet; and
tracing the at least one character from the character page onto the top sheet using a writing instrument.

20. The method of claim 19 further including erasing marks created by the writing instrument.
